(19) United States
(12) Patent Application Publication
(10) Pub. No.: US 2024/0381244 A1
(43) Pub. Date: Nov. 14, 2024

(54) STICKY CLIENT DETECTOR FOR WIRELESS NETWORKS

(71) Applicant: Cisco Technology, Inc., San Jose, CA (US)

(72) Inventors: Jerome HENRY, Pittsboro, NC (US); Pascal THUBERT, Roquefort Les Pins (FR); Jean-Philippe VASSEUR, Saint Martin D'uriage (FR); Robert E. BARTON, Richmond (CA)

(21) Appl. No.: 18/592,281

(22) Filed: Feb. 29, 2024

Related U.S. Application Data
(60) Provisional application No. 63/501,655, filed on May 11, 2023.

(51) Int. Cl. H04W 48/20; H04W 64/00

(52) U.S. Cl. CPC H04W 48/20; H04W 64/006

(57) ABSTRACT

Techniques and apparatus for performing sticky client detection and/or remediation with machine learning are described. An example technique includes determining one or more parameters associated with roaming activity of a client station (STA) within a wireless network. The one or more parameters are evaluated with a machine learning model to predict a sliding boundary associated with the client STA, a first access point (AP) within the wireless network, and a second AP within the wireless network. Information associated with the sliding boundary is transmitted to the first AP. A frame including a request for the client STA to roam to the second AP and the information associated with the sliding boundary is transmitted to the client STA.

### CROSS-REFERENCE TO RELATED APPLICATIONS

This application claims benefit of co-pending U.S. Provisional Patent Application Ser. No. 63/501,655 filed May 11, 2023. The aforementioned related patent application is herein incorporated by reference in its entirety as if fully set forth below and for all applicable purposes.

### TECHNICAL FIELD

Embodiments presented in this disclosure generally relate to wireless communications. More specifically, embodiments disclosed herein relate to techniques for optimizing client roaming within a wireless network.

### BACKGROUND

Wireless networks have long been impacted by sticky clients, which is a term generally used to describe a client station (STA) that stays associated to an access point (AP) long after the client STA has reached the basic service set (BSS) of another AP offering better connection conditions. For example, the roaming process generally involves a client STA deciding to dissociate from one (current) AP and deciding to reassociate to another (new) AP. However, because the roaming process is generally controlled by the client STA itself, this process can lead to scenarios in which some client STAs may not reassociate to a different AP offering better connection conditions.

The presence of sticky clients within a wireless network can impact the performance of the sticky clients themselves as well as the performance of other client STAs within the network. For example, a sticky client in poor connection conditions may communicate using a lower modulation and coding scheme (MCS). In addition, the lower MCS used by sticky client(s) can take a higher proportion of the airtime being shared by all client STAs within the wireless network connected to the same AP as the sticky client(s), impacting the network performance of all client STAs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to one embodiment.

FIG. 2 illustrates an example sticky client scenario, according to one embodiment.

FIG. 3 is a flowchart of a method for training a machine learning model to perform sticky client detection and/or remediation, according to one embodiment.

FIG. 4 is a flowchart of a method for performing sticky client detection and/or remediation, according to one embodiment.

FIG. 5 illustrates an example call flow diagram for sticky client detection and/or remediation, according to one embodiment.

FIG. 6 illustrates an example computing device, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method. The computer-implemented method includes determining one or more parameters associated with roaming activity of a client station (STA) within a wireless network. The computer-implemented method also includes evaluating the one or more parameters with a machine learning model to predict a sliding boundary associated with the client STA, a first access point (AP) within the wireless network, and a second AP within the wireless network. The computer-implemented method further includes transmitting information associated with the sliding boundary to at least one of the first AP or the second AP.

Another embodiment described herein is a computer-implemented method. The computer-implemented method includes determining, by a first access point (AP), that a sliding boundary associated with a client station (STA), the first AP, and a second AP in a wireless network satisfies a predetermined condition. The computer-implemented also includes, responsive to the determination, transmitting, by the first AP, a frame to the client STA comprising (i) a request for the client STA to roam to the second AP and (ii) information associated with the sliding boundary.

Another embodiment described herein is a first network device. The first network device includes one or more memories collectively storing instructions and one or more processors communicatively coupled to the one or more memories. The one or more processors are collectively configured to execute the instructions to cause the first network device to perform an operation. The operation includes determining that a sliding boundary associated with a client station (STA), the first network device, and a second network device in a wireless network satisfies a predetermined condition. The operation also includes, responsive to the determination, transmitting a frame to the client STA comprising (i) a request for the client STA to roam to the second network device and (ii) information associated with the sliding boundary.

Other embodiments provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein.

### EXAMPLE EMBODIMENTS

In many wireless networks (e.g., wireless local area networks (LANs) (WLANs)), seamless roaming by client STAs (e.g., smartphones, laptops, smartwatches, augmented reality (AR)/virtual reality (VR)/mixed reality (XR) headsets, etc.) between APs plays a crucial role in ensuring the network and user application performance. Although several extensions to wireless communication standards, such as the Institute of Electrical and Electronics Engineers (IEEE) 802.11 technical standard, have been released to improve roaming by aiding clients, one potential drawback to these efforts is the fact that the process of a client STA deciding to dissociate from one AP and reassociate to a new AP (with preferably a better radio frequency connection as indicated by a stronger received signal strength indicator (RSSI)) is generally controlled by the client STA itself.

In particular, in certain cases, the roaming process may be sub-optimal and result in some client STAs staying associated to an AP with a lower RSSI as opposed to reassociating to a different AP with a higher RSSI. Such client STAs that behave in this manner are generally referred to as sticky clients. A sticky client connected to a given AP may experience diminished network performance (e.g., reduced throughput, increased latency, etc.). Additionally, the presence of the sticky client can impact the performance of other client STAs connected to the same AP as the sticky client. For example, a sticky client with a low RSSI may communicate using a lower MCS for successful packet delivery. Packets transmitted with a lower MCS, however, may take a higher proportion of the airtime, which is shared between all client STAs connected to the same AP. As such, other client STAs connected to the same AP as the sticky client(s) can also experience diminished network performance.

In certain cases, the wireless network infrastructure may able to detect the presence of a sticky client. For example, when the client STA probes on a channel where a neighboring AP is operating, the neighboring AP may detect the signal and conclude that the client STA is close to the neighboring AP and far from the serving AP. However, these methods of sticky client detection may be unreliable since they are not deterministic. For example, a client STA may not have a reason to probe on another channel if the client STA does not determine that the existing connection with the serving AP is unsuitable (e.g., due to the client STA being at the edge of the serving cell). Additionally, even if the client STA is detected near another AP, there is no guarantee that, from the client STA's viewpoint, the other AP offers a better connection than the serving AP, as this determination may depend on the client STA's roaming algorithm. At the same time, ignoring the presence of a sticky client(s) may lead to sub-optimal performance of the sticky client(s) as well as other client STAs in the network. For example, as noted, sticky clients may use a lower MCS for successful packet delivery which can take a higher proportion of the airtime shared between all client STAs of the serving cell.

Certain embodiments described herein provide techniques and apparatus for performing sticky client detection and/or remediation (e.g., mitigating the occurrence of sticky clients in a wireless network) using machine learning (ML). According to certain embodiments herein, one or more ML models are trained to detect whether a client STA has or will become a sticky client to a serving AP and/or predict a likelihood of a client STA successfully associating with a target AP. As described in greater detail herein, the ML model(s) may be trained on a dataset including one or more parameters associated with roaming events (e.g., probe requests, probe responses, authentication requests, authentication responses, beacon reports, neighbor reports, etc.) in the network. The parameter(s) associated with a given roaming event may be indicative of a quality of a communication link between a client STA and an AP when the roaming event occurs (e.g., signal strength of an association/authentication frame received at an AP from a client STA).

In some cases, the dataset used for training the ML model(s) may also include an indication of roaming stability of one or more client STAs in the network. For example, the indication of roaming stability for a given client STA may indicate (i) whether the client STA sends an authentication request after probing a given AP and (ii) if the client STA associates with the AP, an amount of time that the client STA stays connected to the AP. In some cases, the dataset used for training the ML model(s) may also include one or more AP parameters (e.g., quality of service (QoS) basic service set (BSS) (QBSS) load, AP power and AP operating channel, etc.). In some cases, the dataset used for training the ML model(s) may also include, if available, an indication of each type of client STA in the network (e.g., the dataset may include parameters indicating the device original equipment manufacturer (OEM), device operating system (OS) type and version, and device capabilities, as illustrative, non-limiting examples).

In certain embodiments, a sticky client detector (also referred to as a sticky client detection engine) may use the ML model(s) to evaluate one or more roaming parameters (e.g., measured RF parameters of the client STA, etc.) in a network and predict, for each of one or more client STAs in the network, an indication of whether the client STA is a sticky client to a serving AP and/or a likelihood of the client STA successfully associating with a target AP for a given position of the client STA between the serving AP and the target AP. The position of the client STA may be a current or predicted position. The (current or predicted) position of the client STA between the serving AP and the target AP may be inferred (or determined) from a (measured or predicted) signal strength level of the client STA at the serving AP. As described in greater detail herein, the prediction may be in the form of a predictive sliding boundary between BSSs.

In one example, the predictive sliding boundary may indicate, for each position of the client STA between a first (serving) AP associated with a first BSS and a second (target) AP associated with a second BSS, the predicted signal strength for the client STA on the second (target) AP. In addition to, or as an alternative to, indicating the predicted signal strength for the client STA on the second AP, the predictive sliding boundary may indicate, for each position of the client STA, the predicted MCS for the client STA when associated with the second AP. In addition to, or as an alternative to, indicating the predicted signal strength and/or predicted MCS for the client STA on the second AP, the predictive sliding boundary may indicate, for each position of the client STA, the predicted likelihood of a successful association of the client STA with the second AP along with a confidence level associated with the predicted likelihood of successful association. The sticky client detector may continually update (or adjust) the predictive sliding boundary over time, based on observed (or measured) roaming parameters in the network. The position of the client STA between the first AP and the second AP may be determined from a signal strength level of a client STA on the first (serving) AP associated with the first BSS.

In certain embodiments, the sticky client detector, based on the predictive sliding boundary, may trigger a first AP to transmit a roaming frame to a client STA (served by the first AP) suggesting that the client STA should roam to a second AP offering better network conditions. For example, when the sticky client detector determines, based on the predictive sliding boundary, that at least one predictive radio frequency (RF) parameter associated with the second AP (e.g., predicted signal strength level, predicted modulation and coding scheme (MCS), etc.) for a given position of the client STA exceeds the corresponding RF parameter associated with the first AP (by a threshold), then the sticky client detector may trigger the first AP to transmit a roaming frame to the client STA. In another example, when the sticky client detector determines, based on the predictive sliding boundary, that the predicted likelihood of successful association with the second AP for a given position of the client STA is greater than a threshold, then the sticky client detector may trigger the first AP to transmit a roaming frame to the client STA. In yet another example, when the sticky client detector determines, based on the predictive sliding boundary, that the client STA has a status of a sticky client at a given position of the client STA, then the sticky client detector may trigger the first AP to transmit a roaming frame to the client STA.

The roaming frame may indicate at least one of an identifier of the second AP (along with a suggestion that the client STA should roam to the second AP), operating channel of the second AP, the given (current or predicted) position of the client STA, the at least one predictive RF parameter for the position of the client STA, the predicted likelihood of successful association for the position of the client STA, a confidence level associated with the predicted likelihood of successful association, an indication that the client STA has a status of a sticky client at the position of the client STA, or a combination thereof. Upon receiving the roaming frame, the client STA may evaluate the information within the roaming frame using a roaming algorithm to determine whether to roam to the second AP (e.g., by disassociating from the first AP and reassociating with the second AP).

Advantageously, the techniques described herein can significantly improve the communication performance (e.g., increased throughput, lower latency, lower interference, etc.) of client STAs within a wireless network by improving the detection of sticky clients and mitigating the occurrence of such sticky clients. As such, embodiments herein can improve the seamless roaming performance of client STAs within a network.

Note, the techniques described herein for performing sticky client detection and/or remediation in a wireless network may be incorporated into (such as implemented within or performed by) a variety of wired apparatuses (or nodes), wireless apparatuses (or nodes), or a combination thereof. A wireless node may provide, for example, connectivity to or from a network (such as a wide area network (WAN) such as the Internet or a cellular network) via a wired or wireless communication link. In some implementations, a wireless node may include a computing system, a controller, or an AP.

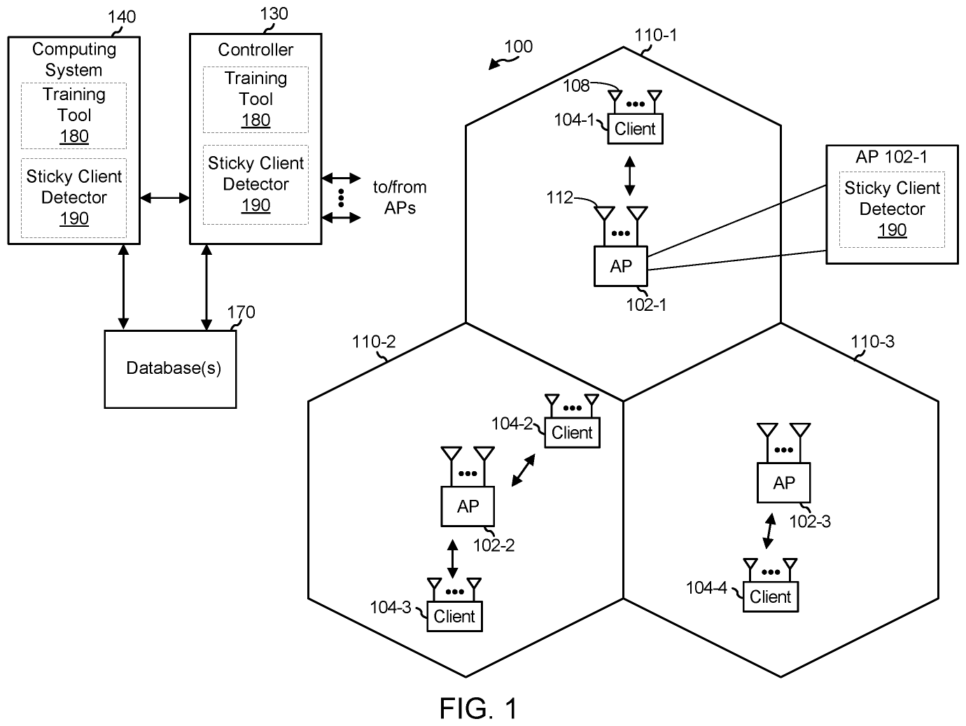

FIG. 1 illustrates an example system in which one or more techniques described herein can be implemented, according to one embodiment. As shown, the system 100 includes, without limitation, one or more APs (e.g., AP 102-1, AP 102-2, and AP 102-3), one or more client STAs (e.g., client STA 104-1, client STA 104-2, client STA 104-3, and client STA 104-4), a controller 130, a computing system 140, and one or more databases 170.

An AP is generally a fixed station that communicates with client STA(s) and may be referred to as a base station, wireless device, or some other terminology. A client STA may be fixed or mobile and also may be referred to as a mobile STA, a client, a STA, a wireless device, or some other terminology. Note that while a certain number of APs and client STAs are depicted, the system 100 may include any number of APs and client STAs.

As used herein, an AP along with the STAs associated with the AP (e.g., within the coverage area (or cell) of the AP) may be referred to as a BSS. Here, BSS 110-1 includes AP 102-1 and client STA 104-1 served by AP 102-1, BSS 110-2 includes AP 102-2 and client STAs 104-2 and 104-3 served by AP 102-2, and BSS 110-3 includes AP 102-3 and client STA 104-4 served by AP 102-3. The AP 102-1, AP 102-2, and AP 102-3 are neighboring (peer) APs. The APs 102 may communicate with one or more client STAs 104 on the downlink and uplink. The downlink (e.g., forward link) is the communication link from the AP 102 to the client STA(s) 104, and the uplink (e.g., reverse link) is the communication link from the client STA(s) 104 to the AP 102. In some cases, a client STA may also communicate peer-to-peer with another client STA.

As shown in FIG. 1, each client STA 104 includes one or more radios 108. The client STA 104 can use one or more of the radios 108 to form links with an AP 102. As also shown, each AP 102 includes one or more radios 112 that the AP 102 can use to form links with one or more client STAs 104 and/or one or more APs 102. In general, the AP(s) 102 and the client STA(s) 104 may form any suitable number of links for communication using any suitable frequencies and using any suitable communication protocols. In some instances, a client STA 104 may form multiple links with a single AP 102.

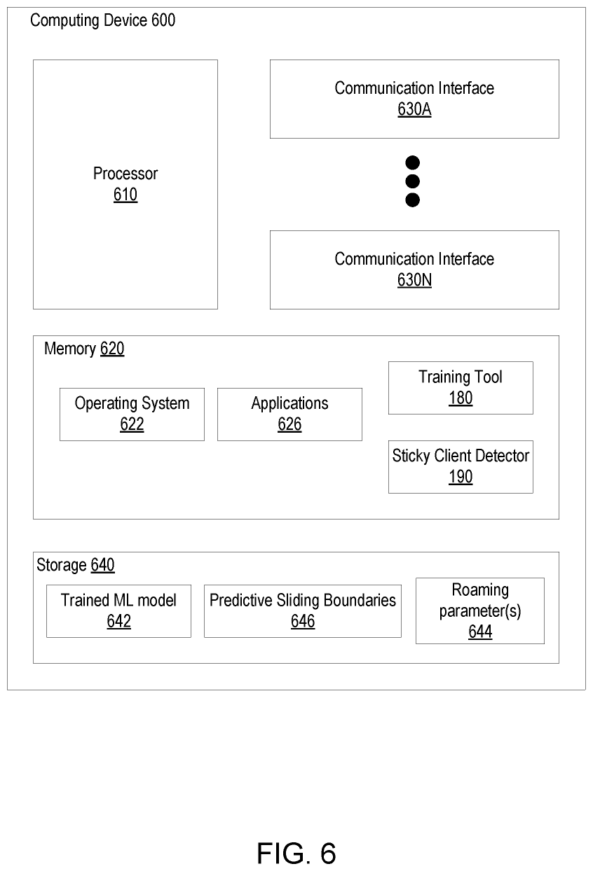

The operations of the controller 130 may be implemented by any device or system, and may be combined or distributed across any number of systems. For example, the controller 130 may be a wireless local area network (WLAN) controller for the APs 102 within the system 100. In some examples, the controller 130 is included within or integrated with an AP 102 and coordinates the links formed by that AP 102 (or otherwise provides control for that AP). For example, each AP 102 may include a controller that provides control for that AP. In some examples, the controller 130 is separate from the APs 102 and provides control for those APs. In FIG. 1, for example, the controller 130 may communicate with the APs 102 1-3 via a (wired or wireless) backhaul. The APs 102 1-3 may also communicate with one another, e.g., directly or indirectly via a wireless or wireline backhaul. Example hardware that may be included in a controller 130 or AP 102 is discussed in greater detail with regard to FIG. 6.

The database(s) 170 are representative of storage systems that may include historical and/or real-time information associated with (i) roaming messages (e.g., probe requests/responses, authentication requests/responses, etc.) exchanged between client STAs 104 and APs 102 in the network, (ii) beacon messages from APs 102 in the network, (iii) neighbor reports, (iv) neighbor discovery protocol (NDP) messages, (v) signal strength measurements of messages received at APs 102 (e.g., RSSI/signal-to-interference-plus-noise ratio (SINR)/channel state information (CSI) of a last frame from a client STA on AP 102-1, and RSSI/SINR/CSI of an initial frame from the client STA on AP 102-2); (vi) roaming stability of one or more client STAs 104 (e.g., for a given client STA, an indication of how long the client STA stays associated with an AP after associating with that AP), (vii) radio resource configurations (e.g., AP maximum transmit powers), (viii) AP parameters (e.g., QBSS load, AP power, AP operating channel, etc.), (ix) radio resource management (RRM) information, (x) logic (e.g., trained ML models) for performing sticky client detection and/or remediation, (xi) client STA types (e.g., device ecosystem analytics), (xii) AP topological information (e.g., AP positions), or (xiii) any combination thereof.

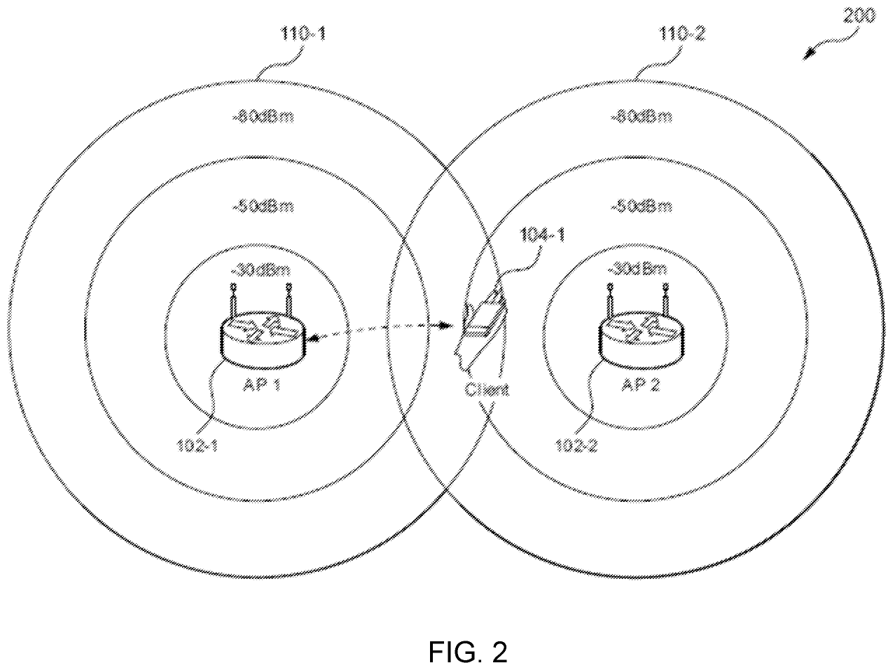

In certain cases, one or more client STAs 104 depicted in FIG. 1 may become sticky clients, where the client STA 104 stays associated to a current AP 102 with a low signal strength (e.g., low RSSI) for a threshold period of time as opposed to reassociating to a new AP 102 with a higher signal strength (e.g., higher RSSI). Consider the example scenario in FIG. 2, which illustrates a system 200 with a sticky client (e.g., client STA 104-1), according to one embodiment. The system 200 may be similar to the system 100 depicted in FIG. 1.

Here, the sticky client remains associated with AP 1 (e.g., AP 102-1) despite having a relatively weaker RSSI compared to neighboring AP 2 (e.g., AP 102-2). For example, the sticky client's RSSI of AP 1 is approximately −80 decibels per milliwatt (dBm) and the sticky client's RSSI of AP 2 is approximately −50 dBm. As used herein, a sticky client may refer to a client STA (i) that is associated to an AP with a signal strength (e.g., RSSI) lower than a threshold (e.g., −65 dBm, −70 dBm, or another signal strength value), (ii) the signal strength of the client STA to the associated AP is lower than the signal strength of the client STA to a neighboring AP by a threshold margin, and (iii) the association to the AP with the lower signal strength has persisted for a threshold amount of time.

As noted, the presence of a sticky client can impact the network performance of all client STAs connected to the AP (e.g., AP 1) that is associated with the sticky client, due to the shared airtime between the client STAs and the use of lower MCS rates by the sticky client. In particular, packets transmitted at lower MCS rates may have longer transmit times than packets transmitted at higher MCS rates, and thus may take up a higher proportion of the shared airtime than packets transmitted at higher MCS rates.

Certain embodiments described herein provide techniques for using machine learning to perform sticky client detection and/or remediation in a wireless network, such as system 100. Referring back to FIG. 1, the computing system 140 includes a training tool 180 and a sticky client detector 190, each of which is configured to implement one or more techniques described herein. Note that while the training tool 180 and sticky client detector 190 are depicted within a single computing system 140, the training tool 180 and sticky client detector 190 may be implemented by one or more computing systems distributed across a cloud computing environment. Additionally, note that while the training tool 180 and sticky client detector 190 are depicted as separate components, in certain embodiments, the training tool 180 and sticky client detector 190 may be implemented by a single component. In certain embodiments, one or more of the operations of the training tool 180 and/or the sticky client detector 190 may be performed by an AP 102. In certain embodiments, one or more of the operations of the training tool 180 and/or the sticky client detector 190 may be performed by a controller 130. The training tool 180 and the sticky client detector 190 may include hardware, software, or combinations thereof.

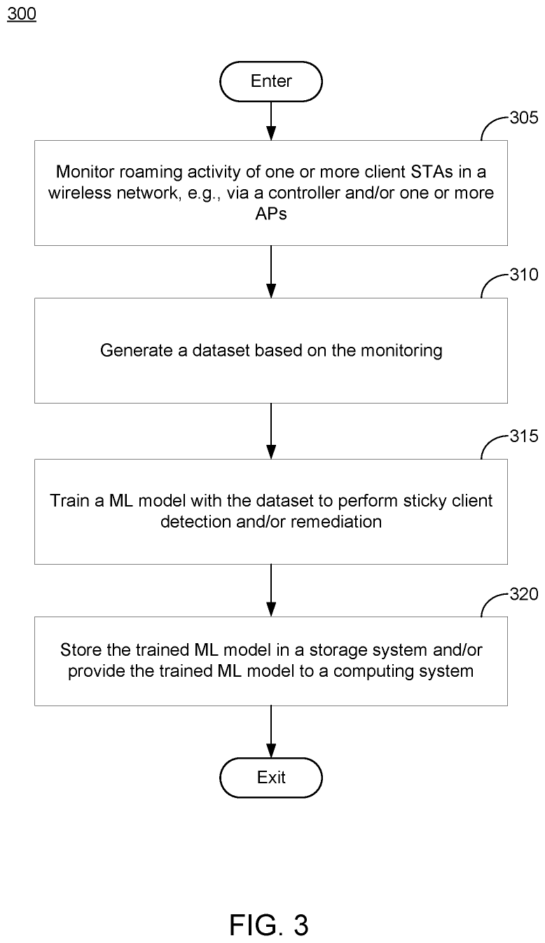

In certain embodiments, the training tool 180 may train one or more ML models to perform sticky client detection and/or remediation. For example, the ML model(s) may be trained to detect whether a client STA is a sticky client to a serving AP and/or a likelihood of a client STA successfully associating with a target AP. FIG. 3 is a flowchart of a method 300 for training a ML model to perform sticky client detection and/or remediation, according to one embodiment. The method 300 may be performed by a training tool, such as training tool 180.

Method 300 may enter at block 305, where the training tool monitors roaming activity of one or more client STAs (e.g., client STA(s) 104) in a wireless network (e.g., system 100), e.g., via the controller (e.g., controller 130) and/or one or more APs (e.g., APs 102). For example, the training tool may monitor, via the controller and/or APs, probe requests sent by client STAs to APs, beacon messages from APs, neighbor reports from APs, roaming stability of client STAs, AP(s) parameters, client STA types, or any combination thereof.

At block 310, the training tool generates a dataset based on the monitoring. The dataset may include a set of information collected (or retrieved) from the controller, one or more AP(s), one or more databases (e.g., database(s) 170), or a combination thereof. The generated dataset may include one or more parameters associated with roaming events, one or more parameters associated with roaming stability of client STA(s), one or more AP(s) parameters, client STA type(s), or any combination thereof.

In some examples, the training tool (at block 310) may generate the dataset, in part, by obtaining, from the APs, the signal strength of each probe request sent by each client STA to the APs and including the signal strength information in the dataset. Additionally, in some examples, the training tool may generate (at block 310) the dataset, in part, by obtaining neighbor report messages (e.g., 802.11k neighbor reports) (including NDP message results between APs) along with beacon report messages (e.g., 802.11k beacon reports) from one or more APs, and including the neighbor report messages, NDP message results, and beacon report messages in the dataset.

In some examples, the training tool (at block 310) may generate the dataset, in part, by determining the roaming stability of each client STA in the network and including the roaming stability information in the dataset. The roaming stability of a client STA may be represented by the amount of time the client STA stays connected with an AP after associating with that AP. Here, the training tool may obtain the roaming stability information from the controller and/or the AP(s). For example, the training tool may obtain an index (from the controller and/or a given AP) indicating (i) whether a client STA sent an authentication request to the AP after probing for the AP and (ii) if the client STA associated with the AP, an amount of time that the client STA was connected to the AP. In addition to the roaming stability information, the training tool may query each AP for one or more AP parameters, such as QBSS load, AP power and operating channel, as illustrative, non-limiting examples, and include the AP parameters in the dataset.

In some examples, the training tool may generate (at block 310) the dataset, in part, by determining each type of each client STA in the wireless network, and including the client STA type information in the dataset. The training tool may obtain the client STA type information from the controller and/or AP(s). The client STA type information may indicate, for a given client STA, the device OEM, device OS type and version, and device capabilities, as illustrative, non-limiting examples. In certain embodiments, the training tool may correlate other roaming information obtained via the controller and/or APs based on the client STA types. For example, the training tool may create (and include within the dataset) a first group of roaming parameters for a first type of client STAs, create a second group of roaming parameters for a second type of client STAs, and so on.

At block 315, the training tool trains an ML model with the dataset to perform sticky client detection (e.g., predict a likelihood of a client STA becoming a sticky client) and/or remediation (e.g., mitigate an occurrence of sticky clients in a network). At block 320, the training tool stores the ML model in a storage system and/or provides the ML model to a computing system. For example, as described in greater detail herein, a sticky client detector (e.g., sticky client detector 190) may obtain and utilize the trained ML model to perform sticky client detection and/or remediation.

Note that the training tool may use any suitable artificial intelligence (AI)/ML technique to train the ML model (e.g., at block 315). Such techniques may include gradient boosting trees, logistic regression, support vector machines, random forest algorithms, k-nearest neighbors algorithm (k-NN), deep-learning algorithms, and adaptive boosting, as illustrative, non-limiting examples. In certain embodiments, the training tool may train the ML model offline (referred to as offline machine learning or batch learning). For example, the training tool may monitor the roaming activity of one or more client STAs over a period of time (e.g., minute(s), hour(s), day(s), or some other period of time) (block 305), generate a dataset based on the monitoring for the period of time (block 310), and train the ML model offline based on the dataset (block 315). In certain embodiments, the training tool may train the ML model online (referred to as online machine learning). For example, the training tool may train the ML model online (e.g., in real-time) as data, based on the operations in block 305 and 310, becomes available. Training the ML model online may allow the training tool to adapt to rapidly changing conditions in the wireless network. In certain embodiments, the training tool may train the ML model offline and online. For example, the training tool may train an ML model offline based on historical data associated with roaming activity of client STAs in one or more first wireless networks, and train the ML model online based on real-time data associated with roaming activity of client STAs in a second (current) wireless network.

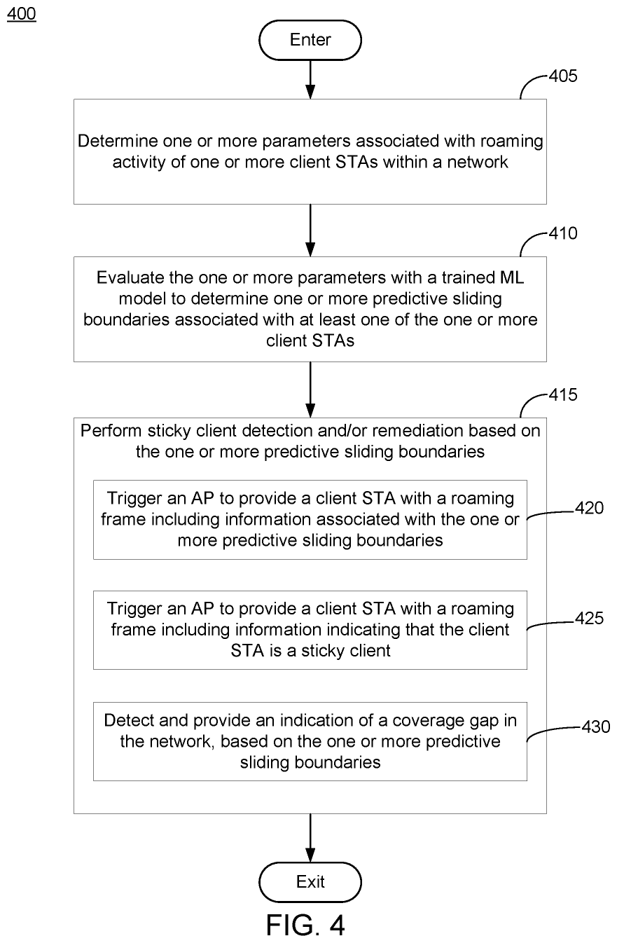

FIG. 4 is a flowchart of a method 400 for performing sticky client detection and/or remediation, according to one embodiment. The method 400 may be performed by a sticky client detector, such as sticky client detector 190.

Method 400 may enter at block 405, where the sticky client detector determines one or more parameters associated with roaming activity of one or more client STAs (e.g., client STA(s) 104) within a network (e.g., system 100). The parameters, for example, may include information indicating signal strength of one or more probe requests from client STA(s) in the network, measured RF parameters (e.g., signal strength, MCS, etc.) of the client STA at the APs, neighbor report messages from APs (e.g., APs 102) in the network, beacon report messages from APs in the network, roaming stability information, one or more AP(s) parameters, client STA types, or a combination thereof.

At block 410, the sticky client detector evaluates the one or more parameters with a trained ML model (e.g., trained ML model generated in FIG. 3) to determine one or more predictive sliding boundaries associated with at least one of the one or more client STAs. For example, the sticky client detector may output, via the trained ML model, for a given client STA, at least one predictive sliding boundary between a first AP (e.g., AP 102-1) associated with a first BSS (e.g., BSS 110-1) and a second AP (e.g., AP 102-2) associated with a second BSS (e.g., BSS 110-2). Each predictive sliding boundary may be a dynamic value that varies based on a current set of parameters associated with the first AP and the second AP (e.g., current {AP1, AP2} parameters), the client STA position, the client STA type, or a combination thereof. Note, the set of parameters associated with the first AP and the second AP may include any combination of the aforementioned information in block 405.

In certain embodiments, each predictive sliding boundary may depend, in part, on the client STA's physical position in the cell, the current serving AP for the client STA, the target AP of the client STA, or a combination thereof. For example, for a given signal strength of the client STA at an AP(s) (e.g., first AP, second AP, or a combination thereof), the client STA may be at a particular position among the APs (e.g., between the first AP and a third AP (e.g., AP 102-3), between the first AP and the second AP, or between the second AP and a fourth AP (e.g., AP 102-4), as illustrative examples).

In certain embodiments, a predictive sliding boundary may indicate, for each position of the client STA (inferred from the signal strength level of the client STA on a serving AP), the predicted signal strength level of the client STA on a potential target AP. In addition to, or as an alternative to, indicating the predicted signal strength, in certain embodiments, the predictive sliding boundary may indicate, for each position of the client STA, a predicted MCS of the client STA at the target AP. In addition to, or as an alternative to, indicating the predicted signal strength and/or predicted MCS, in certain embodiments, the predictive sliding boundary may indicate, for each position of the client STA, a likelihood of a successful association of the client STA on the target AP along with a confidence level associated with the likelihood of successful association (e.g., client STA has X % likelihood of successfully associating with the target AP with a confidence level=Y, where X, Y∈[0 100]). In certain embodiments, at least one of the predictive sliding boundaries may be computed from the perspective of a current serving AP. For example, assuming a client STA is currently associated with a first AP, at least one predictive sliding boundary may indicate, for each position of the client STA, if the client STA were to be associated with a second AP, the likelihood that the client STA would successfully associate to the first AP.

In certain embodiments, each predictive sliding boundary may correspond to a different roaming direction for a given client STA. For example, the sticky client detector may output (via the trained ML model) a first predictive sliding boundary for {AP1, AP2}, where AP1 is the current serving AP and AP2 is the target AP, and output a second predictive sliding boundary for {AP2, AP1}, where AP2 is the current serving AP and AP1 is the target AP. The first predictive sliding boundary may be used to predict a likelihood of the client STA, if it were to associate with AP2, successfully associating with AP2, e.g., as the client STA moves from AP1 to AP2. Additionally, the first predictive sliding boundary may be used to detect whether the client STA has become a sticky client to AP1, e.g., as the client STA moves from AP1 to AP2. The second predictive sliding boundary may be used to predict a likelihood of the client STA, if it were to associate with AP1, successfully associating with AP1, e.g., as the client STA moves from AP2 to AP1. Additionally, the second predictive sliding boundary may be used to detect whether the client STA has become a sticky client to AP2, e.g., as the client STA moves from AP2 to AP1.

At block 415, the sticky client detector performs sticky client detection and/or remediation, based in part on the one or more predictive sliding boundaries. Block 415 may include sub-block 420, sub-block 425, sub-block 430, or a combination thereof.

At sub-block 420, the sticky client detector may trigger an AP to provide a client STA with a roaming frame including information associated with the one or more predictive sliding boundaries. In certain embodiments, the sticky client detector may trigger the AP (e.g., AP 102-1) to send the roaming frame to the client STA (e.g., client STA 104-1) served by the AP when a predictive sliding boundary associated with the client STA satisfies a predetermined condition. In one example, the predetermined condition may include, for a given position of the client STA, a predicted RF parameter (e.g., predicted signal strength level, predicted MCS, etc.) for the client STA on the target AP being greater than a threshold or being greater than a corresponding RF parameter for the client STA on the serving AP by a threshold margin. In another example, the predetermined condition may include, for a given position of the client STA, a predicted likelihood of successful association of the client STA with the target AP being greater than a threshold.

The roaming frame triggered in sub-block 420 may include a request (or suggestion) for the client STA to roam to the target AP. In certain embodiments, the roaming frame may be similar to a BSS transition management (BTM) frame (e.g., BTM request frame defined in 802.11v) that is modified to include information associated with the one or more predictive sliding boundaries. For example, the roaming frame may include an identifier of the target AP (e.g., BSS identifier (BSSID) associated with the second AP), operating channel of the second AP, an indication that the frame type is a “request” (e.g., for the AP to roam to the second AP), a position of the client STA, the predicted RF parameter of the client STA at the target AP for the position of the client STA, the predicted likelihood of successful association of the client STA with the target AP for the position of the client STA, the confidence level associated with the likelihood of successful association, or a combination thereof. In some cases, in response to the roaming frame, the client STA may send another roaming frame (e.g., a BTM response frame defined in 802.11v) indicating whether the client STA accepts or denies the request.

At sub-block 425, the sticky client detector triggers the AP to provide a client STA with a roaming frame including information indicating that the client STA is a sticky client at a current position of the client STA and/or a predicted position where the client STA will become a sticky client. In one example scenario, assuming the client STA is within the coverage area of a first AP (e.g., AP1) with a highest possible RSSI (e.g., the client STA has a line-of-sight (LOS) to the first AP and there is no antenna lobe coverage hole between the client STA and serving AP), then the probability of the client STA associating with the first AP may be “1” and the probability of the client STA associating with a second AP (e.g., AP2) may be “x”. As the client STA moves within the coverage of the second AP with a highest possible RSSI, the probability of the client STA associating with the second AP may be “1” and the probability of the client STA associating with the first AP may be “y.”

In this scenario, the sticky client detector may determine that the client STA is a sticky client associated with the first AP at a current position of the client STA when the association probability to the second AP at the position exceeds the association probability to the first AP by a threshold. In another example, the sticky client detector may determine or predict a position (e.g., between the first AP and the second AP) where the client STA will become a sticky client (e.g., a position where the association probability to the second AP exceeds the association probability to the first AP by a threshold).

In certain embodiments, the roaming frame triggered in sub-block 425 may be similar to the roaming frame triggered in sub-block 420. For example, the roaming frame may be similar to a BTM frame (e.g., BTM request frame defined in 802.11v) that is modified to include information associated with the one or more predictive sliding boundaries, information associated with sticky client detection, or a combination thereof. For example, the roaming frame may include an identifier of the target AP (e.g., BSS identifier (BSSID) associated with the second AP), operating channel of the second AP, an indication that the frame type is a “request” (e.g., for the AP to roam to the second AP), a position of the client STA, the predicted RF parameter of the client STA at the target AP for the position, the predicted likelihood of successful association of the client STA with the target AP for the position, the confidence level associated with the likelihood of successful association, an indication that the client STA is a sticky client at the position, a predicted position where the client STA will become a sticky client, a flag (e.g., disassociation flag) indicating that the serving AP will disassociate the client STA after a first period of time has elapsed and will decline further reassociation for a second period of time after the first period of time has elapsed, or a combination thereof. In some cases, in response to the roaming frame, the client STA may send another roaming frame (e.g., a BTM response frame defined in 802.11v) indicating whether the client STA accepts or denies the request.

At sub-block 430, the sticky client detector may detect and provide an indication of a coverage gap in the network, based on the one or more predictive sliding boundaries. For example, when the probability of successful association of the client STA with the serving AP falls below a threshold but the probability of successful association of the client STA with a target AP is below another threshold, the sticky client detector may determine there is a coverage gap between the serving AP and target AP. In this example, the sticky client detector may transmit an indication of the coverage gap to a computing system (e.g., controller 130 or a management system associated with the network).

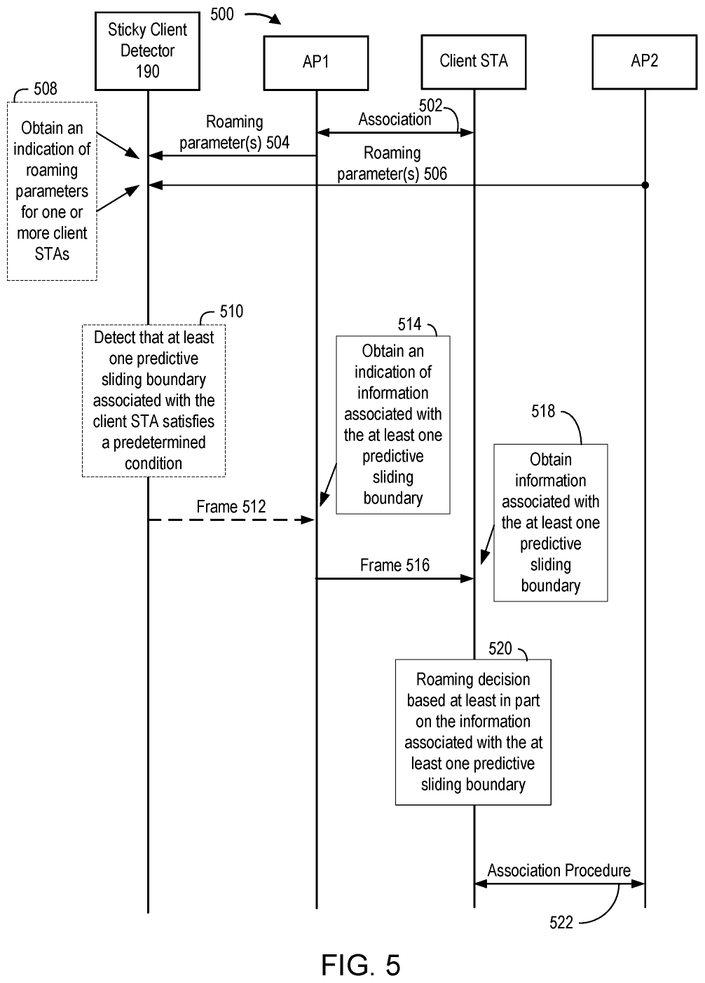

FIG. 5 illustrates an example call flow diagram 500 for sticky client detection and/or remediation, according to one embodiment. The call flow diagram 500 illustrates example signaling between a sticky client detector 190, AP1 (e.g., AP 102-1), a client STA (e.g., client STA 104-1), and AP2 (e.g., AP 102-2).

In some cases, as indicated at 502, the client STA may initially be associated with AP1. While the client STA is associated with AP1, the sticky client detector may obtain, via AP1, roaming parameters 504 associated with one or more client STAs (e.g., client STAs 104-1 to 104-K, including the client STA 104-1) in the network, and may obtain, via AP2, roaming parameters 506 associated with one or more other client STAs (e.g., client STAs 104-(K+1) to 104-N) in the network. As noted, such roaming parameters 504, 506 may include information indicating signal strength of one or more probe requests from client STA(s) in the network, measured RF parameters (e.g., signal strength, MCS, etc.) of the client STA at the APs, neighbor report messages from APs (e.g., APs 102) in the network, beacon report messages from APs in the network, roaming stability information, one or more AP(s) parameters, client STA types, or a combination thereof.

As indicated at 510, the sticky client detector (using a trained ML model generated via the training tool 180) detects that at least one predictive sliding boundary associated with the client STA and corresponding to a roaming direction from AP1 to AP2 satisfies a predetermined condition. After determining that the at least one predictive sliding boundary satisfies the predetermined condition, the sticky client detector sends a frame 512 to AP1 including information associated with the at least one predictive sliding boundary. As indicated at 514, the AP1 may obtain an indication of the information associated with the at least one predictive sliding boundary. As noted, the information associated with the at least one predictive sliding boundary may include a predicted RF parameter of the client STA at AP2, a predicted likelihood of successful association of the client STA with AP2, a confidence level associated with the likelihood of successful association, an indication that the client STA is a sticky client, a predicted position where the client STA will become a sticky client, or a combination thereof.

The frame 512 may trigger the AP1 to send a roaming frame 516 to the client STA that includes the information associated with the at least one predictive sliding boundary. In certain embodiments, the roaming frame 516 may also include an indication that the frame type is a “request” for the client STA to roam to AP2, a flag indicating that AP1 will dissociate the client STA and will decline further reassociation for a certain period of time, or a combination thereof.

As indicated at 518, the client STA may obtain the information associated with the at least one predictive sliding boundary along with other information included within the roaming frame 516. As indicated at 520, the client STA may make a roaming decision based at least in part on the information within the roaming frame 516. For example, the client STA may incorporate the information associated with the at least one predictive sliding boundary into a roaming algorithm (or protocol) (implemented at the client STA) in order to determine whether and/or when to dissociate from AP1 and initiate an association procedure 522 with AP2. The roaming algorithm implemented at the client STA may be any suitable roaming algorithm/protocol including roaming protocols defined in 802.11k/v/r, as illustrative, non-limiting examples.

Note that while FIG. 5 depicts the sticky client detector 190 being separate from AP1, in certain embodiments, the sticky client detector 190 may be integral with AP1. In such embodiments, the AP1 may be configured to perform the operations indicated at 508, 510, 512, or a combination thereof.

Advantageously, the techniques described herein allow for efficiently detecting sticky clients, mitigating the occurrence of sticky clients, and detecting coverage gaps. The techniques described herein can enable an AP(s) to signal information associated with predict sliding boundaries to client STAs to allow the client STA's roaming algorithms to adapt to local network conditions. For example, using the techniques described herein, a serving AP can predict the target AP the client STA should roam to and transmit, to the client STA, (i) an indication of the likelihood of successful association to the target AP (with a confidence level) and (ii) an indication of the position between the serving AP and target AP where the likelihood of successful association exceeds a threshold (e.g., to optimize the roam time). After indicating to the client STA the next roaming target and probability, the techniques described herein allow for observing whether the client STA has roamed (or not). If the client STA has not roamed, the techniques described herein allow for determining the likelihood that the client STA has a satisfactory connection to the serving AP (without the roam) (e.g., the client STA is not a sticky client), detecting whether there is a coverage gap, and detecting whether the client STA has become a sticky client. The techniques described herein allow for alerting the client STA to its sticky client status, with optional remediation involving dissociating the client STA from the serving AP. In this manner, the techniques described herein can improve the seamless roaming performance of client STAs within a network.

FIG. 6 illustrates an example computing device 600, according to one embodiment. The computing device 600 can be configured to perform one or more techniques described herein for performing sticky client detection and/or remediation. For example, the computing device 600 can perform method 300, method 400, and any other techniques (or combination of techniques) described herein. The computing device 600 may be representative of a controller (e.g., controller 130), a computing system (e.g., computing system 140), or a network entity (e.g., an AP, such as AP 102). The computing device 600 includes, without limitation, a processor 610, a memory 620, one or more communication interfaces 630a-n. In one example, a communication interface 630 includes a radio.

The processor 610 may be any processing element capable of performing the functions described herein. The processor 610 represents a single processor, multiple processors, a processor with multiple cores, and combinations thereof. The communication interfaces 630 (e.g., radios) facilitate communications between the computing device 600 and other devices. The communications interfaces 630 may include wireless communications antennas and various wired communication ports.

The memory 620 may be either volatile or non-volatile memory and may include RAM, flash, cache, disk drives, and other computer readable memory storage devices. Although shown as a single entity, the memory 620 may be divided into different memory storage elements such as RAM and one or more hard disk drives. As shown, the memory 620 includes various instructions that are executable by the processor 610 to provide an operating system 622 to manage various functions of the computing device 600. The memory 620 also includes a training tool 180, a sticky client detector 190, and one or more application(s) 626.

The computing device 600 may include storage 640. In some cases, the storage 640 may be a disk drive or flash storage device. In some cases, the storage 640 may be a combination of fixed and/or removable storage devices, such as fixed disc drives, solid state drives, removable memory cards, optical storage, network attached storage (NAS), or a storage area-network (SAN). The storage 640 may include a trained ML model 642, one or more predictive sliding boundaries (including information associated therewith) 646, roaming parameter(s) 644, or any combination thereof, as illustrative, non-limiting examples.

### Example Clauses

In addition to the various embodiments described above, certain example embodiments are within the scope of the disclosure, some of which are detailed below:

Clause 1: A computer-implemented method comprising: determining one or more parameters associated with roaming activity of a client station (STA) within a wireless network; evaluating the one or more parameters with a machine learning model to predict a sliding boundary associated with the client STA, a first access point (AP) within the wireless network, and a second AP within the wireless network; and transmitting information associated with the sliding boundary to at least one of the first AP or the second AP.

Clause 2: The computer-implemented method of Clause 1, wherein the sliding boundary indicates, for each position of the client STA between the first AP and the second AP, one or more respective predicted radio frequency (RF) parameters of the client STA at the second AP.

Clause 3: The computer-implemented method of Clause 2, wherein the one or more predicted RF parameters comprise a predicted signal strength, a predicted modulation and coding scheme (MCS), or a combination thereof.

Clause 4: The computer-implemented method according to any of Clauses 2-3, wherein each position of the client STA between the first AP and the second AP is based on a respective signal strength of the client STA at the first AP.

Clause 5: The computer-implemented method according to any of Clauses 1-4, wherein the sliding boundary indicates, for each position of the client STA between the first AP and the second AP, (i) a predicted likelihood of successful association of the client STA with the second AP and (ii) a confidence level associated with the predicted likelihood of successful association of the client STA with the second AP.

Clause 6: The computer-implemented method according to any of Clauses 1-5, further comprising determining that the sliding boundary satisfies a predetermined condition, wherein the information associated with the sliding boundary is transmitted after determining that the sliding boundary satisfies a predetermined condition.

Clause 7: The computer-implemented method of Clause 6, wherein the predetermined condition comprises, for a position of the client STA between the first AP and the second AP, a radio frequency (RF) parameter of the client STA at the second AP that is predicted by the sliding boundary being greater than a threshold.

Clause 8: The computer-implemented method of Clause 7, wherein the position of the client STA is predicted position of the client STA between the first AP and the second AP.

Clause 9: The computer-implemented method according to any of Clauses 6-8, wherein the predetermined condition comprises, for a position of the client STA between the first AP and the second AP, (i) a likelihood of successful association of the client STA with the second AP that is predicted by the sliding boundary being greater than a first threshold and (ii) a confidence level associated with the likelihood of successful association of the client STA that is predicted by the sliding boundary being greater than a second threshold.

Clause 10: The computer-implemented method of Clause 9, wherein the position of the client STA is a predicted position of the client STA between the first AP and the second AP.

Clause 11: The computer-implemented method according to any of Clauses 1-10, wherein the information associated with the sliding boundary comprises at least one of (i) a predicted radio frequency (RF) parameter of the client STA at the second AP corresponding to a position of the client STA between the first AP and the second AP, (ii) a predicted likelihood of successful association of the client STA at the second AP corresponding to the position of the client STA between the first AP and the second AP, (iii) a confidence level associated with the predicted likelihood of successful association of the client STA at the second AP, or (iv) an indication that the client STA has a status of a sticky client at the position of the client STA between the first AP and the second AP.

Clause 12: The computer-implemented method according to any of Clauses 1-11, further comprising: detecting a coverage gap between the first AP and the second AP based on the sliding boundary; and transmitting an indication of the coverage gap to a computing system.

Clause 13: A computer-implemented method comprising: determining, by a first access point (AP), that a sliding boundary associated with a client station (STA), the first AP, and a second AP in a wireless network satisfies a predetermined condition; and responsive to the determination, transmitting, by the first AP, a frame to the client STA comprising (i) a request for the client STA to roam to the second AP and (ii) information associated with the sliding boundary.

Clause 14: The computer-implemented method of Clause 13, wherein: the sliding boundary indicates, for each position of the client STA between the first AP and the second AP, one or more respective predicted radio frequency (RF) parameters of the client STA at the second AP; and the predetermined condition comprises, for a first position of the client STA between the first AP and the second AP, at least one of the one or more predicted RF parameters of the client STA at the second AP being greater than a threshold for the at least one of the one or more predicted RF parameters.

Clause 15: The computer-implemented method of Clause 14, wherein the information associated with the sliding boundary comprises an indication of the first position and the at least one of the one or more predicted RF parameters of the client STA at the first position.

Clause 16: The computer-implemented method according to any of Clauses 13-15, wherein: the sliding boundary indicates, for each position of the client STA between the first AP and the second AP, a respective predicted likelihood of successful association of the client STA with the second AP; and the predetermined condition comprises, for a first position of the client STA between the first AP and the second AP, the predicted likelihood of successful association of the client STA with the second AP being greater than a threshold.

Clause 17: The computer-implemented method of Clause 16, wherein the information associated with the sliding boundary comprises an indication of the first position and the predicted likelihood of successful association of the client STA with the second AP at the first position.

Clause 18: The computer-implemented method according to any of Clauses 13-17, wherein: the sliding boundary indicates, for each position of the client STA between the first AP and the second AP, an indication of whether the client STA has a status of a sticky client; and the predetermined condition comprises, for a first position of the client STA between the first AP and the second AP, the client STA having the status of the sticky client.

Clause 19: The computer-implemented method of Clause 18, wherein the information associated with the sliding boundary comprises an indication of the first position and an indication that the client STA has the status of the sticky client at the first position.

Clause 20: A first network device comprising: one or more memories collectively storing instructions; and one or more processors communicatively coupled to the one or more memories, the one or more processors being collectively configured to execute the instructions to cause the first network device to perform an operation comprising: determining that a sliding boundary associated with a client station (STA), the first network device, and a second network device in a wireless network satisfies a predetermined condition; and responsive to the determination, transmitting a frame to the client STA comprising (i) a request for the client STA to roam to the second network device and (ii) information associated with the sliding boundary.

Clause 21: A computing device comprising: one or more memories collectively storing instructions; and one or more processors communicatively coupled to the one or more memories, the one or more processors being collectively configured to execute the instructions to cause the computing device to perform a method in accordance with any of Clauses 1-12.

Clause 22: An apparatus, comprising means for performing a method in accordance with any of Clauses 1-12.

Clause 23: A non-transitory computer-readable medium storing executable instructions that, when executed by one or more processors of a computing device, cause the computing device to perform a method in accordance with any of Clauses 1-12.

Clause 24: A computing device comprising: one or more memories collectively storing instructions; and one or more processors communicatively coupled to the one or more memories, the one or more processors being collectively configured to execute the instructions to cause the computing device to perform a method in accordance with any of Clauses 13-19.

Clause 25: An apparatus, comprising means for performing a method in accordance with any of Clauses 13-19.

Clause 26: A non-transitory computer-readable medium storing executable instructions that, when executed by one or more processors of a computing device, cause the computing device to perform a method in accordance with any of Clauses 13-19.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method comprising:
determining one or more parameters associated with roaming activity of a client station (STA) within a wireless network;
evaluating the one or more parameters with a machine learning model to predict a sliding boundary associated with the client STA, a first access point (AP) within the wireless network, and a second AP within the wireless network; and
transmitting information associated with the sliding boundary to at least one of the first AP or the second AP.

2. The computer-implemented method of claim 1, wherein the sliding boundary indicates, for each position of the client STA between the first AP and the second AP, one or more respective predicted radio frequency (RF) parameters of the client STA at the second AP.

3. The computer-implemented method of claim 2, wherein the one or more predicted RF parameters comprise a predicted signal strength, a predicted modulation and coding scheme (MCS), or a combination thereof.

4. The computer-implemented method of claim 2, wherein each position of the client STA between the first AP and the second AP is based on a respective signal strength of the client STA at the first AP.

5. The computer-implemented method of claim 1, wherein the sliding boundary indicates, for each position of the client STA between the first AP and the second AP, (i) a predicted likelihood of successful association of the client STA with the second AP and (ii) a confidence level associated with the predicted likelihood of successful association of the client STA with the second AP.

6. The computer-implemented method of claim 1, further comprising determining that the sliding boundary satisfies a predetermined condition, wherein the information associated with the sliding boundary is transmitted after determining that the sliding boundary satisfies a predetermined condition.

7. The computer-implemented method of claim 6, wherein the predetermined condition comprises, for a position of the client STA between the first AP and the second AP, a radio frequency (RF) parameter of the client STA at the second AP that is predicted by the sliding boundary being greater than a threshold.

8. The computer-implemented method of claim 7, wherein the position of the client STA is predicted position of the client STA between the first AP and the second AP.

9. The computer-implemented method of claim 6, wherein the predetermined condition comprises, for a position of the client STA between the first AP and the second AP, (i) a likelihood of successful association of the client STA with the second AP that is predicted by the sliding boundary being greater than a first threshold and (ii) a confidence level associated with the likelihood of successful association of the client STA that is predicted by the sliding boundary being greater than a second threshold.

10. The computer-implemented method of claim 9, wherein the position of the client STA is a predicted position of the client STA between the first AP and the second AP.

11. The computer-implemented method of claim 1, wherein the information associated with the sliding boundary comprises at least one of (i) a predicted radio frequency (RF) parameter of the client STA at the second AP corresponding to a position of the client STA between the first AP and the second AP, (ii) a predicted likelihood of successful association of the client STA at the second AP corresponding to the position of the client STA between the first AP and the second AP, (iii) a confidence level associated with the predicted likelihood of successful association of the client STA at the second AP, or (iv) an indication that the client STA has a status of a sticky client at the position of the client STA between the first AP and the second AP.

12. The computer-implemented method of claim 1, further comprising:
detecting a coverage gap between the first AP and the second AP based on the sliding boundary; and
transmitting an indication of the coverage gap to a computing system.

13. A computer-implemented method comprising:
determining, by a first access point (AP), that a sliding boundary associated with a client station (STA), the first AP, and a second AP in a wireless network satisfies a predetermined condition; and
responsive to the determination, transmitting, by the first AP, a frame to the client STA comprising (i) a request for the client STA to roam to the second AP and (ii) information associated with the sliding boundary.

14. The computer-implemented method of claim 13, wherein:
the sliding boundary indicates, for each position of the client STA between the first AP and the second AP, one or more respective predicted radio frequency (RF) parameters of the client STA at the second AP; and
the predetermined condition comprises, for a first position of the client STA between the first AP and the second AP, at least one of the one or more predicted RF parameters of the client STA at the second AP being greater than a threshold for the at least one of the one or more predicted RF parameters.

15. The computer-implemented method of claim 14, wherein the information associated with the sliding boundary comprises an indication of the first position and the at least one of the one or more predicted RF parameters of the client STA at the first position.

16. The computer-implemented method of claim 13, wherein:
the sliding boundary indicates, for each position of the client STA between the first AP and the second AP, a respective predicted likelihood of successful association of the client STA with the second AP; and
the predetermined condition comprises, for a first position of the client STA between the first AP and the second AP, the predicted likelihood of successful association of the client STA with the second AP being greater than a threshold.

17. The computer-implemented method of claim 16, wherein the information associated with the sliding boundary comprises an indication of the first position and the predicted likelihood of successful association of the client STA with the second AP at the first position.

18. The computer-implemented method of claim 13, wherein:
the sliding boundary indicates, for each position of the client STA between the first AP and the second AP, an indication of whether the client STA has a status of a sticky client; and
the predetermined condition comprises, for a first position of the client STA between the first AP and the second AP, the client STA having the status of the sticky client.

19. The computer-implemented method of claim 18, wherein the information associated with the sliding boundary comprises an indication of the first position and an indication that the client STA has the status of the sticky client at the first position.

20. A first network device comprising:
one or more memories collectively storing instructions; and
one or more processors communicatively coupled to the one or more memories, the one or more processors being collectively configured to execute the instructions to cause the first network device to perform an operation comprising:
determining that a sliding boundary associated with a client station (STA), the first network device, and a second network device in a wireless network satisfies a predetermined condition; and
responsive to the determination, transmitting a frame to the client STA comprising (i) a request for the client STA to roam to the second network device and (ii) information associated with the sliding boundary.
